(19) United States
(12) Patent Application Publication
(10) Pub. No.: US 2021/0003244 A1
(43) Pub. Date: Jan. 7, 2021

(54) Digital device accessory and stand

(71) Applicant: Daniel Chen Bowman, Minneapolis, MN (US)

(72) Inventor: Daniel Chen Bowman, Minneapolis, MN (US)

(21) Appl. No.: 16/786,676

(22) Filed: Feb. 10, 2020

Related U.S. Application Data
(60) Provisional application No. 62/804,826, filed on Feb. 13, 2019.

(51) Int. Cl. F16M 11/10

(52) U.S. Cl. CPC F16M 11/10; F16M 2200/024

(57) ABSTRACT

The invention is directed to an accessory that attaches to the back of a mobile device or a mobile device case. The accessory includes a base unit including two baseplates each including male elements which when inserted into female cavities on an attachable arm create pivot joints. In use one baseplate would be attached to the back surface of a mobile device. The pivot joints allow one of the base plates to move in a transverse and/or perpendicular direction from the back of the other baseplate and the mobile device. This provides a stand that is highly stable and operational under a variety of conditions.

### CROSS REFERENCE TO RELATED APPLICATIONS

This application claims priority under 35 USC § 119(e) to U.S. Provisional Application No. 62/804,826 filed Feb. 13, 2019, which is herein incorporated by reference in its entirety.

### BACKGROUND OF THE DISCLOSURE

### Field of the Invention

The invention relates to an accessory for a digital device that is attachable to the back of a mobile device and that allows the device to be placed in a variety of standing positions on a surface.

### Description of the Related Art

Existing accessory stands for digital devices typically use, for example, a leg that folds out from the back of the device which allows the device to be propped up into typically one possible viewing angle. Such stands, however, are unstable and often unable to hold the weight of the device. Existing stands also generally require a perfectly flat and stable surface and even the slightest deviation from ideal conditions can render the stand unusable.

### SUMMARY OF THE INVENTION

The invention is directed to an accessory that, for example, attaches to the back of a mobile device or a mobile device case. The accessory includes a base unit including two baseplates and male elements which when inserted into female cavities on the base plate create pivot joints. The pivot joints allow one of the base plates to move in a transverse and/or perpendicular direction from the back of the mobile device. This provides a stand that is highly stable and operational under a variety of conditions.

Other features and aspects will be apparent from the following detailed description, the drawings, and the claims.

### BRIEF DESCRIPTION OF THE DRAWINGS

FIG. 1A shows one embodiment of a base unit of the invention.

FIG. 1B shows a side view of one embodiment of a base unit.

FIG. 1C shows a perspective view of one embodiment of a base unit.

FIG. 2A shows one embodiment of an arm including female elements and serrated grooves.

FIG. 2B shows a side view of an arm.

FIG. 2C shows an isometric perspective view of an arm.

FIG. 2D shows a sectional side view of an arm, female ends, and serrated grooves.

FIG. 3 shows a three-dimensional view of the digital device accessory in one possible open position.

FIG. 4A shows an example of a faceplate attached to a baseplate.

FIG. 4B shows an example of a snap-on, snap-off, faceplate attached to a baseplate.

FIG. 5 shows another view of a digital device accessory of the present disclosure.

FIG. 6 shows another view of an embodiment of the present disclosure.

FIG. 7 shows another embodiment of an accessory of the present invention.

FIG. 8A shows an embodiment of a faceplate and faceplate bottom of the disclosure.

FIG. 8B shows an isometric perspective view of a faceplate and faceplate bottom.

FIG. 8C shows a sectional view of a faceplate and faceplate bottom.

FIG. 9 shows another embodiment of a digital device accessory of the present invention.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the products and/or systems described herein. However, various changes, modifications, and equivalents of the products and/or systems described herein will be apparent to an ordinary skilled artisan.

The invention is directed to an accessory attachable to the back of a mobile device, for example, a cell phone, a tablet, or other similar device. It may also be attached to a mobile device's protective case with, in one embodiment, high grade adhesive, or through any other equivalent means known in the art to attach such an accessory to the back of a device or a device case. A kit including the accessory would also include instructions for set up and application of the accessory. The accessory can be made from plastic, composite, metals and metal alloys, lightweight metals including aluminum, or any other equivalent material known and used in the art.

Preferred embodiments include a base unit comprised of two baseplates and male elements which, when inserted into female cavities on an arm create a pivot joint. There may be two male elements on each baseplate and two female cavities on each arm. The arms may also include female elements or convex portions which connect to the male elements to create an interlocking joint. Serrated grooves on the female elements allow incremental motion which provides adaptability to various user hand sizes, viewing angles, and varying surface conditions including non-level surface conditions. In addition, the serrated grooves provide a frictional fit of the arm with the base unit providing stability. The pivot joint provides motion of varying degrees to create an articulating stand, wherein one of the base plates moves, oscillates, or ratchets, in degrees in a transverse and/or perpendicular direction from the back surface of the digital device.

The accessory may be used to position a phone, tablet, mobile, or other like devices in a vertical (portrait orientation) or horizontal (landscape orientation) display on surfaces such as tabletops and other like surfaces, to better allow a user to view the device hands-free. The baseplates provide sufficient surface area for inclusion of faceplates for branding, such as logos or other copy that may be individualized for particular users. Other images or slogans evocative of social or pop culture references may also be displayed. The faceplates may be attached at manufacture or in another embodiment with a snap-on snap-off feature which allows use of an interchangeable collection of faceplates.

The two baseplates may be configured with one attached to a mobile phone or phone case, or other mobile device, while the other is pivoted by the arms. The display surfaces of the two may be oriented to display a single, coherent image when the movable baseplate is extended or inactive.

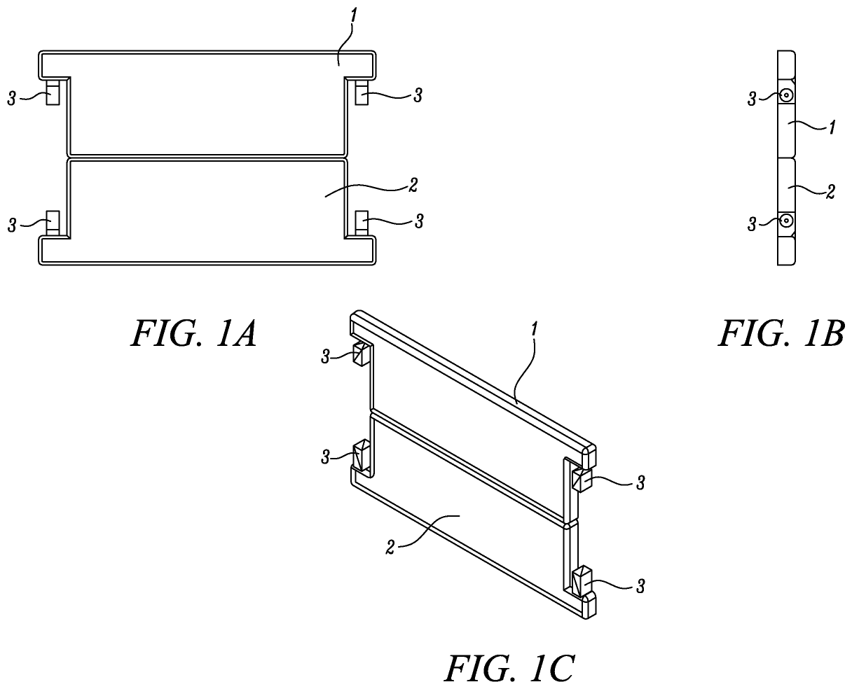

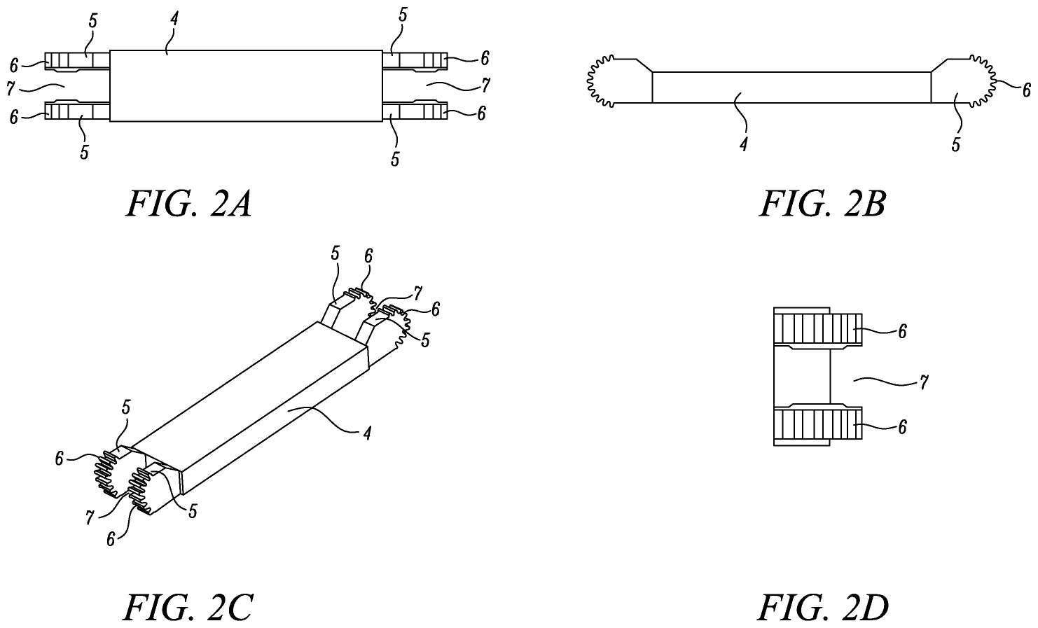

FIG. 1 shows one embodiment of the base plates of the invention. FIG. 1A shows a topographical view of the base unit including baseplate 1 and baseplate 2. One of baseplate 1 or baseplate 2 may be attached to the back surface of a digital device. The other baseplate 1 or 2 can open, oscillate, or ratchet, etc., in degrees, or open in a transverse and/or perpendicular direction. Male elements 3 in conjunction with female elements 5 (shown in FIG. 2) create a pivot joint. FIG. 1B shows a side view of the base unit shown in FIG. 1A. FIG. 1C shows an isometric view of the base unit of the base unit of FIG. 1A.

FIG. 2 shows various perspective views of one embodiment of arm 4 including female elements 5 with serrated grooves 6 that form a cavity 7 that connects with male elements 3 to form pivot joints. FIG. 2A shows arm 4, female elements 5, and serrated grooves 6 forming cavity 7. FIG. 2B shows a side view of arm 4. FIG. 2C shows an isometric perspective of arm 4. FIG. 2D shows a blown-up perspective view of female elements 5 and serrated grooves 6.

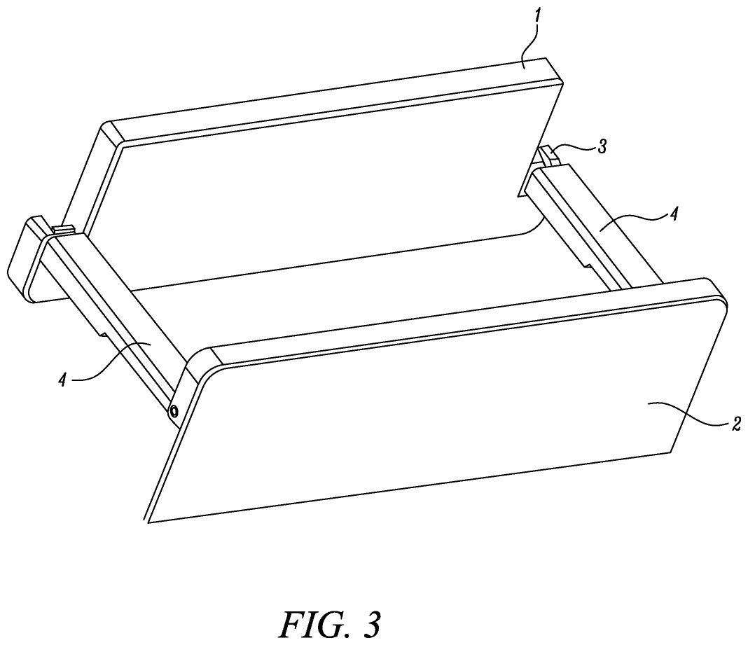

FIG. 3 shows a view of one embodiment of the invention showing the base plates in one possible expanded position. As discussed above, female elements 5 with serrated grooves 6 allow a wide variety of positions to be attained.

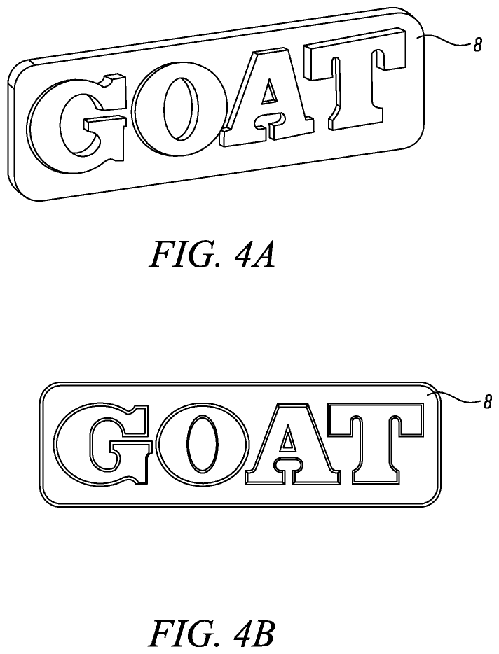

FIG. 4 shows two embodiments of baseplates that can be attached to the accessory.

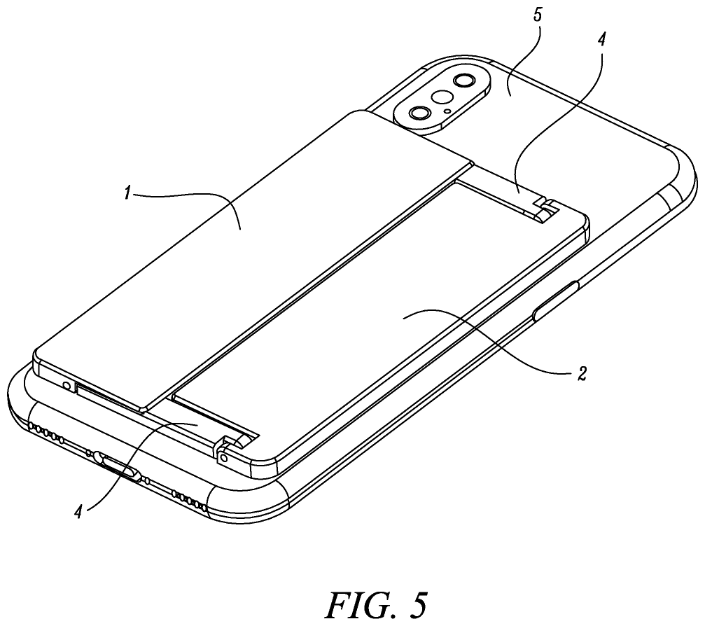

FIG. 5 shows another view of a digital device accessory of the present disclosure. In FIG. 5, the accessory is attached in a closed position to the back of cell phone 5.

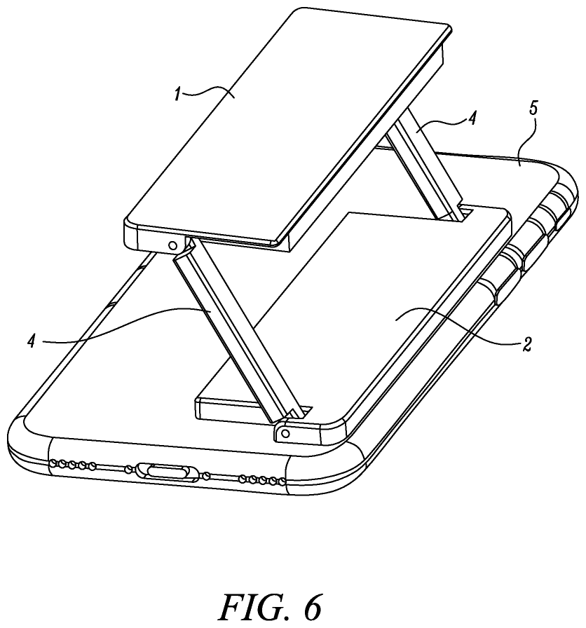

FIG. 6 shows another view of an embodiment of the present disclosure. In FIG. 6, the accessory is in an open position.

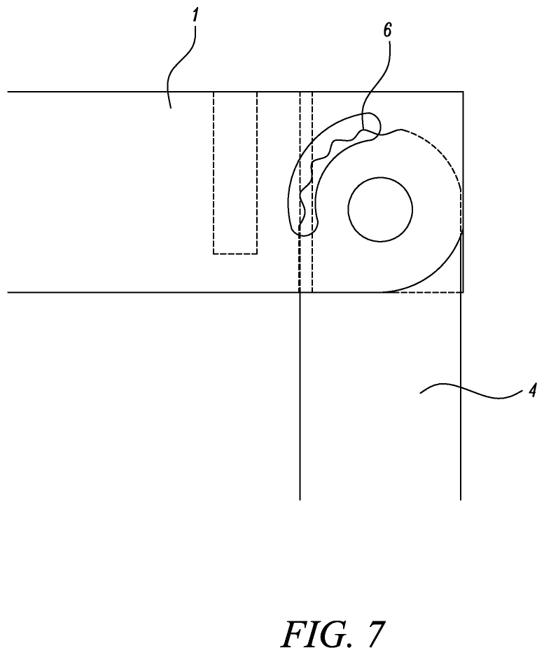

FIG. 7 shows another embodiment of an accessory of the present invention. In FIG. 7, bumps 6 are used on the pivot joint to provide better feel and added tension.

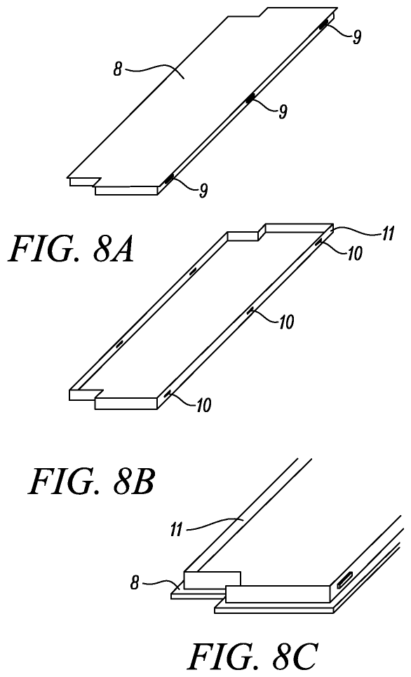

FIG. 8 shows an embodiment of a faceplate and faceplate bottom of the disclosure.

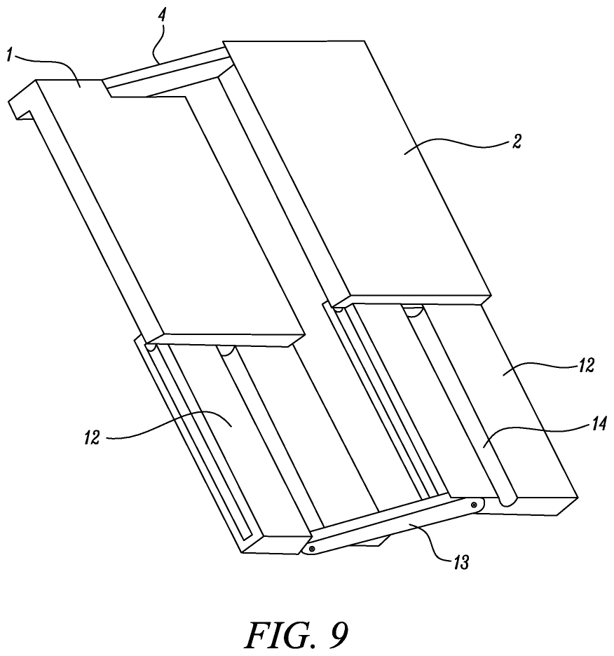

FIG. 9 shows an embodiment wherein an extension section is connected to both baseplates. The extension section includes extension plates 12 with grooves each attached to an extension bar 13. The extension section allows the base plates to accommodate, for example, a RAZR™ phone.

In the embodiment shown in FIG. 9, the plates may be modified to reach the same dimensions as that shown in previous embodiments although from a truncated state. A sliding feature allows the handstand to start from a ‘smaller’ state, in embodiments for example 55% smaller. A grooved feature provides stability necessary due to additional movement to attach to a smaller surface, for example, a Motorola RAZR™.

While this disclosure includes specific examples, it will be apparent after an understanding of the disclosure of this application has been attained that various changes in form and details may be made in these examples without departing from the spirit and scope of the claims and their equivalents

What is claimed is:

1. A digital device accessory comprising:
a base unit comprising two baseplates wherein each baseplate includes male elements;
an arm including female elements capable of connecting with the male elements, wherein the connection between the female elements and male elements form a pivot joint;
wherein one baseplate is capable of moving in a transverse and/or perpendicular direction with respect to a face of the other baseplate via the pivot joints.

2. The digital device accessory of claim 1, wherein a female element comprises serrated grooves.

3. The digital device accessory of claim 1, wherein one baseplate is attachable to the back surface of a digital device and the other baseplate is capable of moving in a transverse and/or perpendicular direction with respect to the other baseplate.

4. The digital device accessory of claim 3, wherein one baseplate is attachable to the back surface of the digital device with an adhesive.

5. The digital device accessory of claim 1, wherein the digital device accessory comprises plastic.

6. The digital device accessory of claim 1, comprising two male elements on each baseplate.

7. The digital device accessory of claim 1, comprising two female elements on each arm.

8. The digital device accessory of claim 7, wherein each female element comprises serrated grooves.

9. The digital device accessory of claim 1, wherein one baseplate is capable of moving in a transverse and/or perpendicular direction into a plurality of positions with respect to a face of the other baseplate.

10. The digital device accessory of claim 1, wherein a faceplate is connected to one of the base plates.

11. The digital device accessory of claim 1, wherein the female elements comprise bumps.

12. The digital device accessory of claim 1, wherein the baseplates are each separately connected to an extension plate connected to an extension bar.

13. A kit including:
the digital device accessory of claim 1;
instructions for set-up, and
an adhesive.
